(19) United States
(12) Patent Application Publication
(10) Pub. No.: US 2018/0161234 A1
(43) Pub. Date: Jun. 14, 2018

(54) Telescopic Hand-Held Massager

(71) Applicant: Firstborn Designs, LLC, Broomfield, CO (US)

(72) Inventor: Yvette Dominee, Broomfield, CO (US)

(21) Appl. No.: 15/833,881

(22) Filed: Dec. 6, 2017

Related U.S. Application Data
(60) Provisional application No. 62/433,085, filed on Dec. 12, 2016.

(51) Int. Cl. A61H 15/00

(52) U.S. Cl. CPC A61H 15/0092; A61H 2015/0007; A61H 2205/106; A61H 2205/04; A61H 2205/081

(57) ABSTRACT

An example telescopic hand-held massager includes an extendible and retractable handle and example telescopic hand-held massager a mounting head connected to the handle. The example telescopic hand-held massager also includes a mounting bar threaded on one end into the mounting head, wherein the mounting bar is removable from the mounting head. A massager head slides onto the mounting bar when the mounting bar is removed from the mounting head. The massager head is installed in the mounting head when the mounting bar is threaded into engagement with the mounting head. In an example, the massager head is interchangeable on the mounting head with at least one other massager head. In an example, the mounting head is movably connected to the handle for user configuration of variable angles of operation of the massager head.

### PRIORITY CLAIM

This application claims the priority benefit of U.S. Provisional Patent Application No. 62/433,085 filed Dec. 12, 2016 titled “Telescopic Hand-Held Massager” of Yvette Dominee, hereby incorporated by reference in its entirety as though fully set forth herein.

### BACKGROUND

Massage is a technique of manipulating muscles to relieve tension and provide other therapeutic benefits. Massage therapists are trained to massage particular muscles and groups of muscles to provide these benefits. However, it is not always convenient or affordable to visit a trained massage therapist. There are many home-massage devices available in the marketplace. However, many of these still require another person to operate the device in order to reach all areas on the user's body that might be desired to be massaged (e.g., a person's back).

### BRIEF DESCRIPTION OF THE DRAWINGS

FIGS. 1A and 1B show an example telescopic hand-held massager in 1A) a retracted position and in 1B) an extended position.

FIG. 2 is a perspective view of an example massager head which may be implemented with the telescopic hand-held massager.

FIGS. 3A and 3B show the example telescopic hand-held massager configured with the example massager head of FIG. 2.

FIGS. 4A and 4B show another example massager head which may be implemented with the telescopic hand-held massager. FIG. 4A is a perspective view and FIG. 4B is a side view.

FIGS. 5A and 5B show the example telescopic hand-held massager configured with the example massager head of FIGS. 4A and 4B.

FIGS. 6A and 6B show an example mounting bar for the massager head of the telescopic hand-held massager. FIG. 6A shows the mounting bar in an open configuration to receive a massager head. FIG. 6B shows the mounting bar in a closed configuration to retain the massager head.

FIG. 7 is an exploded view of an example mounting head for the telescopic hand-held massager.

FIGS. 8A and 8B are assembled views of the example mounting head shown in FIG. 7 for the telescopic hand-held massager. FIG. 8A is a front view and FIG. 8B is a side view.

FIGS. 9A and 9B show an example of an elbow portion of the mounting head for the telescopic hand-held massager.

FIGS. 10A and 10B show an example of a t-bar connection of the mounting head for the telescopic hand-held massager.

FIGS. 11A and 11B show an example handle for the telescopic hand-held massager. FIG. 11A shows the handle with an adjustable button removed from the handle. FIG. 11B shows the adjustable button mounted in the handle.

### DETAILED DESCRIPTION

A telescopic hand-held massager is disclosed herein. An example telescopic hand-held massager includes an extendible and retractable handle and example telescopic hand-held massager a mounting head connected to the handle. The example telescopic hand-held massager also includes a mounting bar threaded on one end into the mounting head, wherein the mounting bar is removable from the mounting head. A massager head slides onto the mounting bar when the mounting bar is removed from the mounting head. The massager head is installed in the mounting head when the mounting bar is threaded into engagement with the mounting head.

In an example, the massager head is interchangeable on the mounting head with at least one other massager head. In an example, the mounting head is movably connected to the handle for user configuration of variable angles of operation of the massager head.

In an example, the telescopic hand-held massager includes a telescopic handle with a range to enables reaching all areas of the body by an individual, without needing the help of another person. For purposes of illustration, the telescopic handle may be extended approximately 24 inches to allow the person using the massager to reach areas on the user's body (e.g., the user's back) from a comfortable position. For example, the user may readily reach their back, lower legs, etc., while sitting, standing, or laying down, without putting additional stress on already tired, sore, or cramping muscles.

The massager may be used on any part of the body to relieve sore and tired muscles. The massager may also help to loosen muscles that tightness is causing neck, back, and leg cramps.

The examples described herein are provided for purposes of illustration, and are not intended to be limiting in any manner. Other devices and/or device configurations may be utilized to carry out the operations described herein.

Before continuing, it is noted that as used herein, the terms “includes” and “including” mean, but is not limited to, “includes” or “including” and “includes at least” or “including at least.” The term “based on” means “based on” and “based at least in part on.”

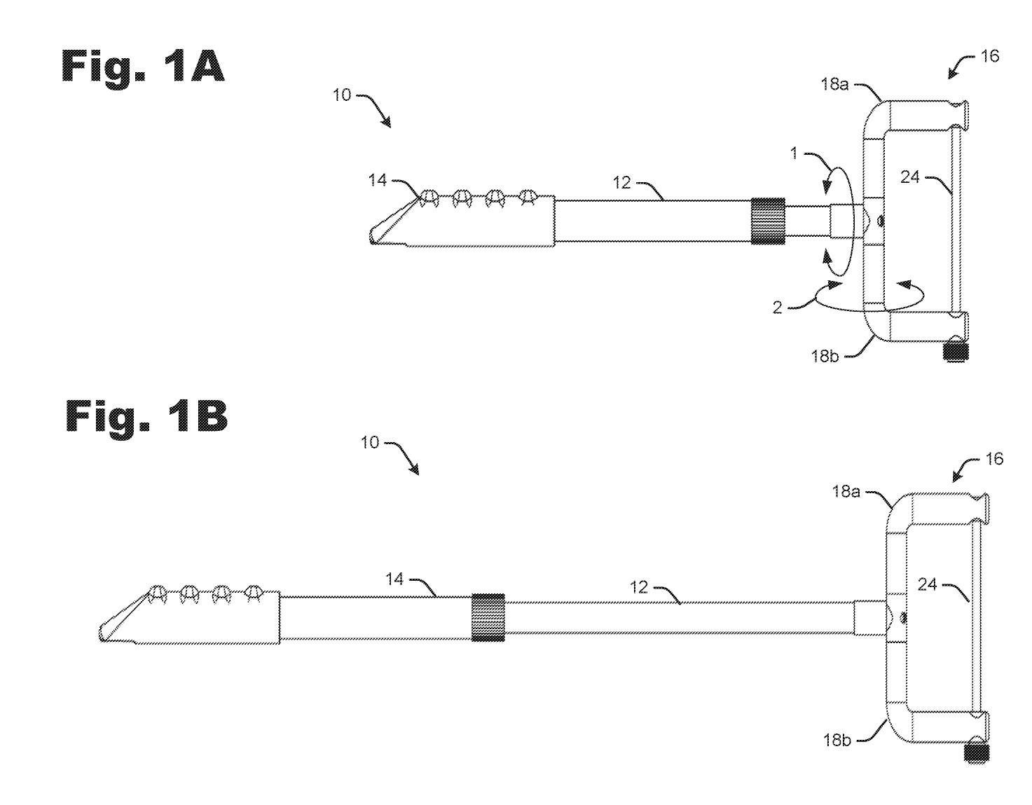

FIGS. 1A and 1B show an example telescopic hand-held massager 10. The hand-held massager is shown in FIG. 1A in a retracted position. The hand-held massager 10 is shown in FIG. 1B in an extended position. In an example, the telescopic hand-held massager 10 includes an extendible (and retractable) handle portion 12. The handle portion 12 may include a grip portion 14 on one end so that the user may readily grasp the handle portion 12 for use.

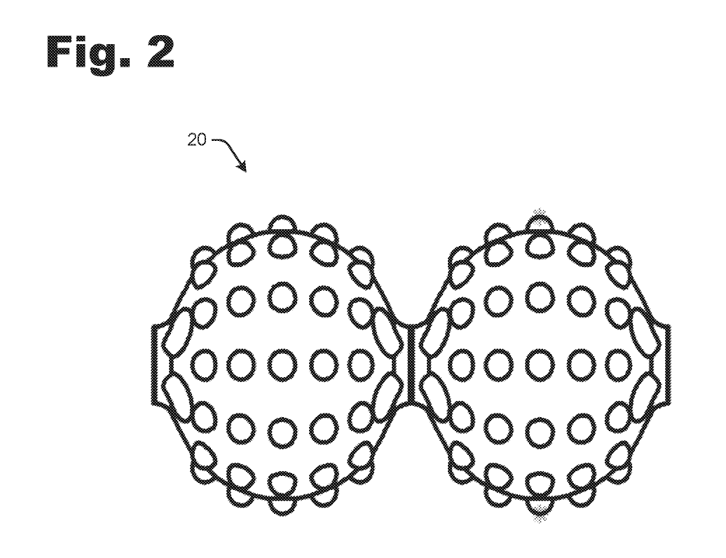

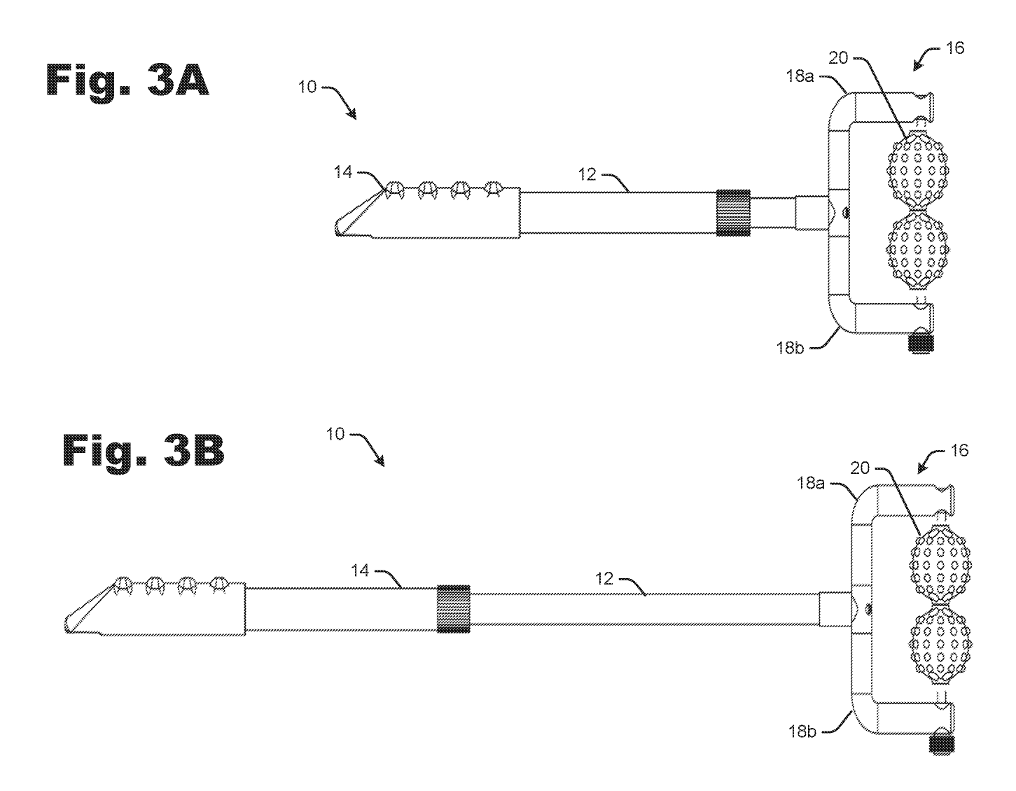

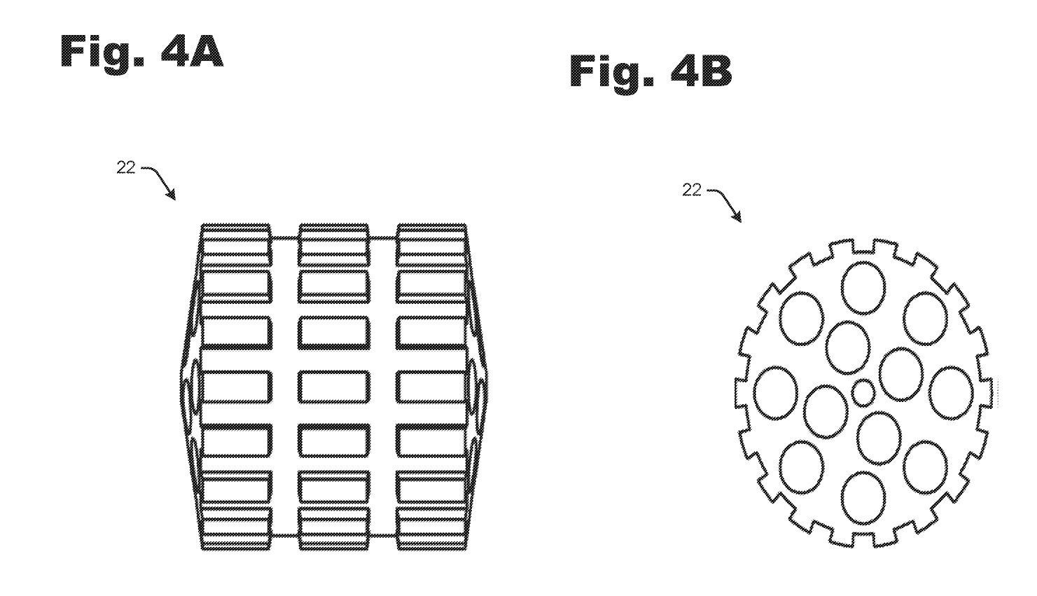

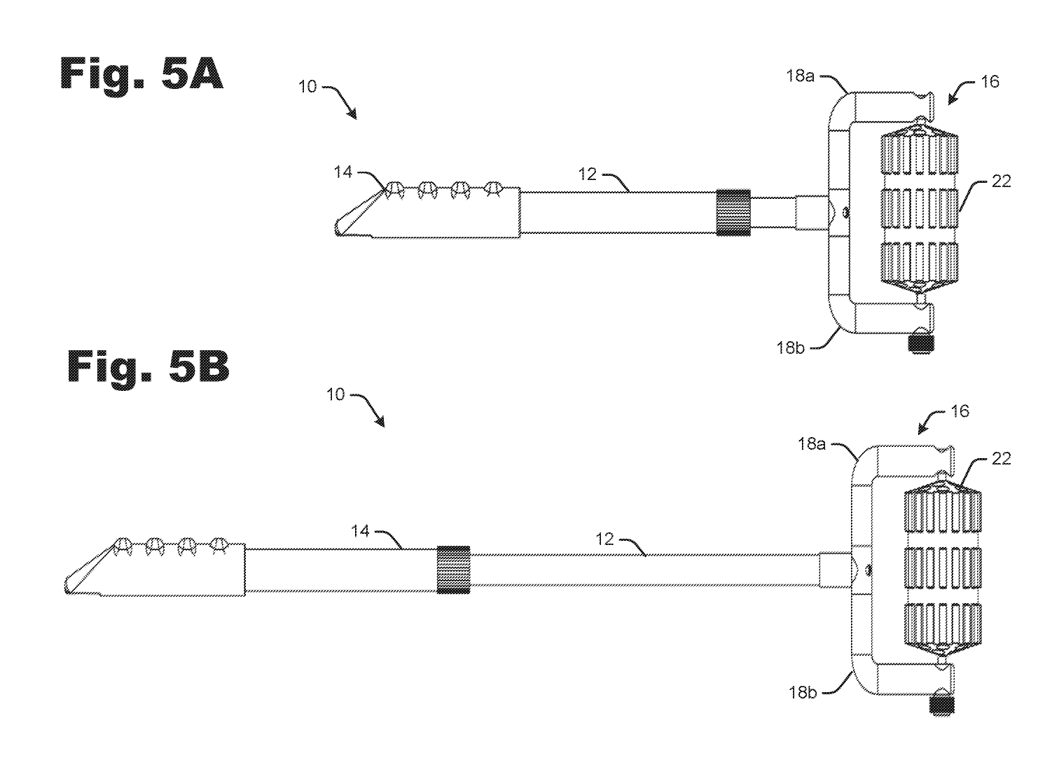

The example telescopic hand-held massager 10 includes a mounting head 16 connected to the handle 12. The example telescopic hand-held massager 10 also includes a massager head (e.g., head 20 in FIG. 2 and head 22 in FIGS. 4A and 4B). In an example, the massager head (e.g., head 20 or head 22) is installed on the opposite end of the handle portion 12. For example, the massager head 20 is shown installed in FIGS. 3A and 3B. The massager head 22 is shown installed in FIGS. 5A and 5B.

A mounting bar 24 may be threaded on one end into the mounting head 16 so that the mounting bar 24 is removable from the mounting head 16. The mounting bar 24 extends between the opposing elbows 18a and 18b of the mounting head 16.

In an example, a mounting bar 24 is threaded on one end into the mounting head 16. The mounting bar 24 may be unscrewed from the mounting head 16 and pulled out of the mounting head 16 so that the massager head can be inserted into the mounting head 16. The mounting bar 24 can then be slid through the massager head and threaded back into the mounting head 16. The massager head 20 or 22 is installed between the elbows 18a and 18b in the mounting head 16 when the mounting bar 24 is threaded into engagement with the mounting head 16.

In an example, the handle portion 12 is manufactured of stainless steel metal. At least a portion of the mounting head 16 may also be manufactured of stainless steel metal. The grip 14 and massager heads 20, 22 may be manufactured of plastic or other desired materials.

In an example, the hand-held massager 10 is approximately 44.5 inches from end to end. The depth of the mounting head 16 is approximately 2.5 to 4 inches allowing the massager head 20, 22 to turn and move across the body. The handle portion 12 may have two sections or more sections that connect inside one another to form a telescopic handle. The grip 14 is ergonomic and may be approximately 5 inches long.

Of course, the various components of the example telescopic hand-held massager 10 may be manufactured of any suitable materials and is not limited to manufacture of any particular type(s) of material(s). Likewise, the telescopic hand-held massager 10 is not limited to any particular dimension(s).

In an example, the massager head 20, 22 is removable from the handle portion and can be interchanged with other massager heads (e.g., different size and/or configuration massager heads).

In an example, the mounting head 16 is movably connected to the handle for user configuration of variable angles of operation of the massager head. The mounting head 16 may be rotatable relative to the handle 12 for user configuration of variable angles of operation of the massager head. For example, the mounting head 16 may rotate or pivot around the handle 12 in the direction indicated by arrows 1 in FIG. 1A, and/or the mounting head 16 may rotate or pivot in the direction indicated by arrows 2 in FIG. 1A.

In an example, different types of massager heads may include one or more balls (e.g., massager head 20) and/or one or more cylinder (e.g., massager head 22). However, the massager head is not limited to a ball or cylinder configuration and those examples are shown only for purposes of illustration. Other shapes (e.g., squares, cylinders, triangles) are also contemplated.

Likewise, the massager head 20, 22 may be a rolling massager head as shown in the Figures. However, the massager head 20, 22 is not limited to a rolling configuration. For example, the massager head 20, 22 may articulate in other manners and/or dimensions, and/or the massager head may be fixed and not move.

FIG. 2 is a perspective view of an example massager head 20 which may be implemented with the telescopic hand-held massager 10. The massager head 20 is shown as it may be configured as a dual roller, e.g., as two balls or spheres. FIGS. 3A and 3B show the example telescopic hand-held massager 10 configured with the example massager head 20 shown in FIG. 2.

In an example, the massager head may include knobby or raised pieces to press onto the muscles.

In an example, the two individual balls of massager head 20 are each approximately 2 to 2.5 inches in diameter. However, the telescopic hand-held massager 10 may be any suitable dimensions and is not limited to those described above.

The massager head 20 may be a fixed massager head. That is, a fixed massager head 20 may not rotate about mounting bar 24. Or the massager head 20 may be an articulating massager head. That is, an articulating massager head 20 may move relative to the mounting bar 24. For example, the massager head 20 may roll on the mounting bar 24. Or for example, the massager head may ratchet on the mounting bar 24.

FIGS. 4A and 4B show another example massager head which may be implemented with the telescopic hand-held massager. FIG. 4A is a perspective view and FIG. 4B is a side view. FIGS. 5A and 5B show the example telescopic hand-held massager configured with the example massager head of FIGS. 4A and 4B.

In an example, the massager head 22 has a surface with a plurality of rectangular shaped massager knobs. Also in this example, the massager head 22 has a gear-shaped side profile. As can be seen in FIG. 4B.

In an example, the cylindrically shaped massager head 22 has a diameter of about 2 to 3 inches and a length of about 4 inches. However, the telescopic hand-held massager 10 may be any suitable dimensions and is not limited to those described above.

The massager head 22 may be a fixed massager head. That is, a fixed massager head 22 may not rotate about mounting bar 24. Or the massager head 22 may be an articulating massager head. That is, an articulating massager head 22 may move relative to the mounting bar 24. For example, the massager head 22 may roll on the mounting bar 24. Or for example, the massager head may ratchet on the mounting bar 24.

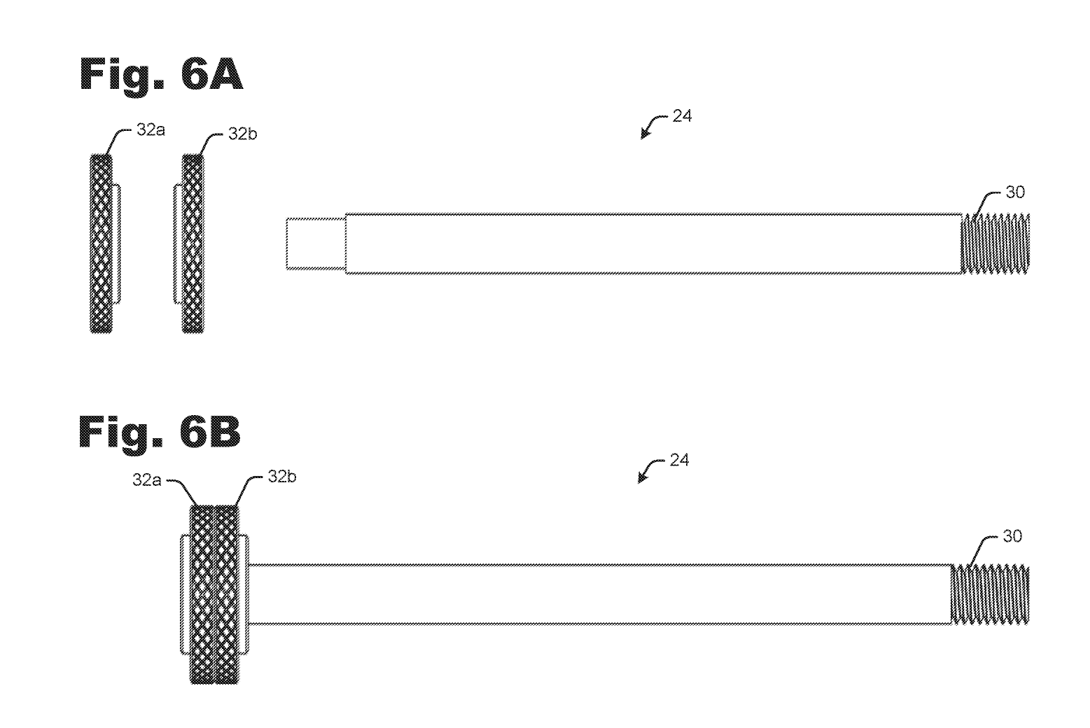

FIGS. 6A and 6B show an example mounting bar 24 for the massager head 20, 22 of the telescopic hand-held massager 10. FIG. 6A shows the mounting bar 24 in an open configuration to receive a massager head 20, 22. FIG. 6B shows the mounting bar 24 in a closed configuration to retain the massager head 20, 22. In an example, the mounting bar 24 includes a threaded end 30 which can be threaded into the elbow 18a of the mounting head 16. Discs 32a and 32b may be provided on the opposite end of the threaded end 30 to enable turning the mounting bar 24 to thread and unthread the threaded end 30 in the elbow 18a.

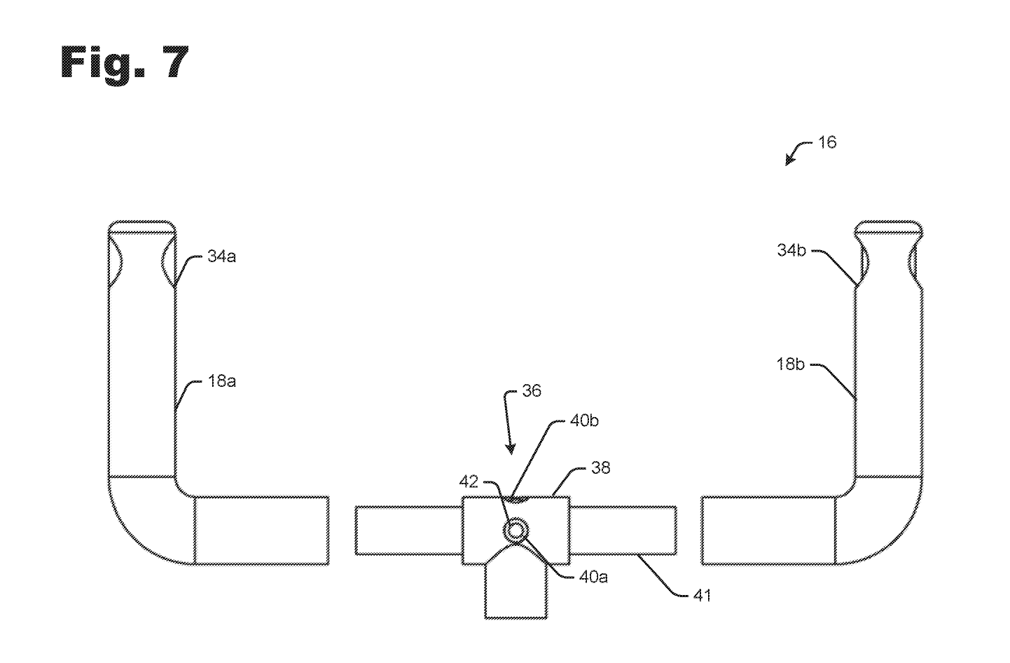

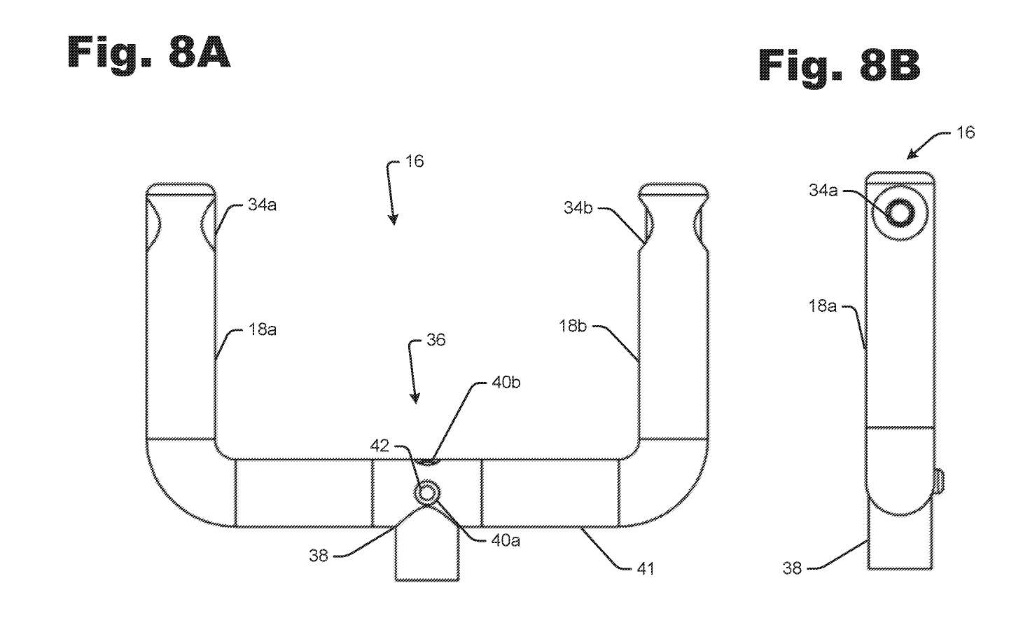

FIG. 7 is an exploded view of an example mounting head 16 for the telescopic hand-held massager 10. FIGS. 8A and 8B are assembled views of the example mounting head 16 shown in FIG. 7 for the telescopic hand-held massager 10. FIG. 8A is a front view and FIG. 8B is a side view of the mounting head 16.

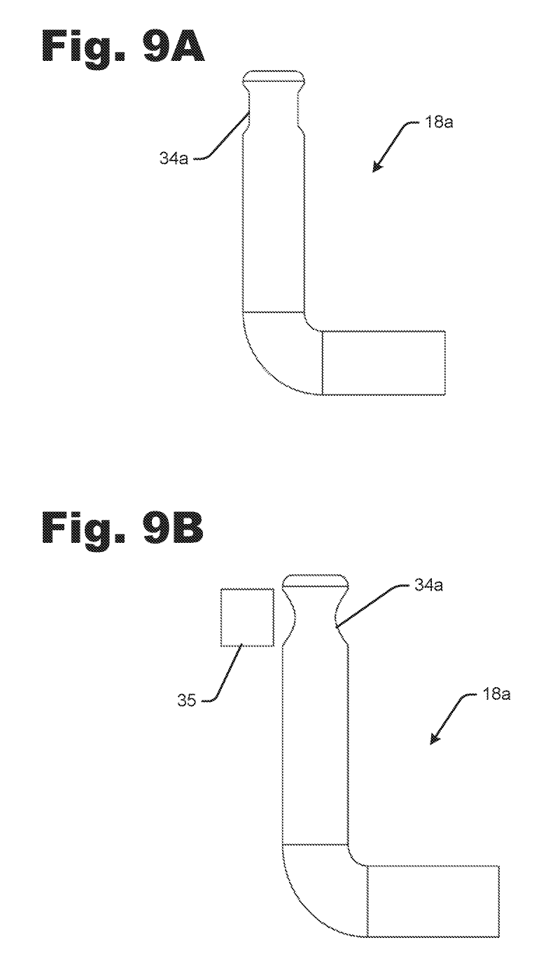

In an example, the mounting head 16 includes elbows 18a and 18b. FIGS. 9A and 9B show an example of an elbow 18a of the mounting head 16 for the telescopic hand-held massager 10. A threaded insert 35 may be provided in opening 34a of elbow 18a. The threaded insert 35 is configured to receive a threaded end 30 of the mounting bar 24, as discussed above for FIGS. 6A and 6B. In another example, the opening 34a itself may be threaded. An opening 34b may also be provided in elbow 18b to receive the mounting bar 24 therethrough. An insert (e.g., rubber gasket) may be provided in the opening 34b to reduce rotation and unthreading of the mounting bar 24 in the mounting head 16.

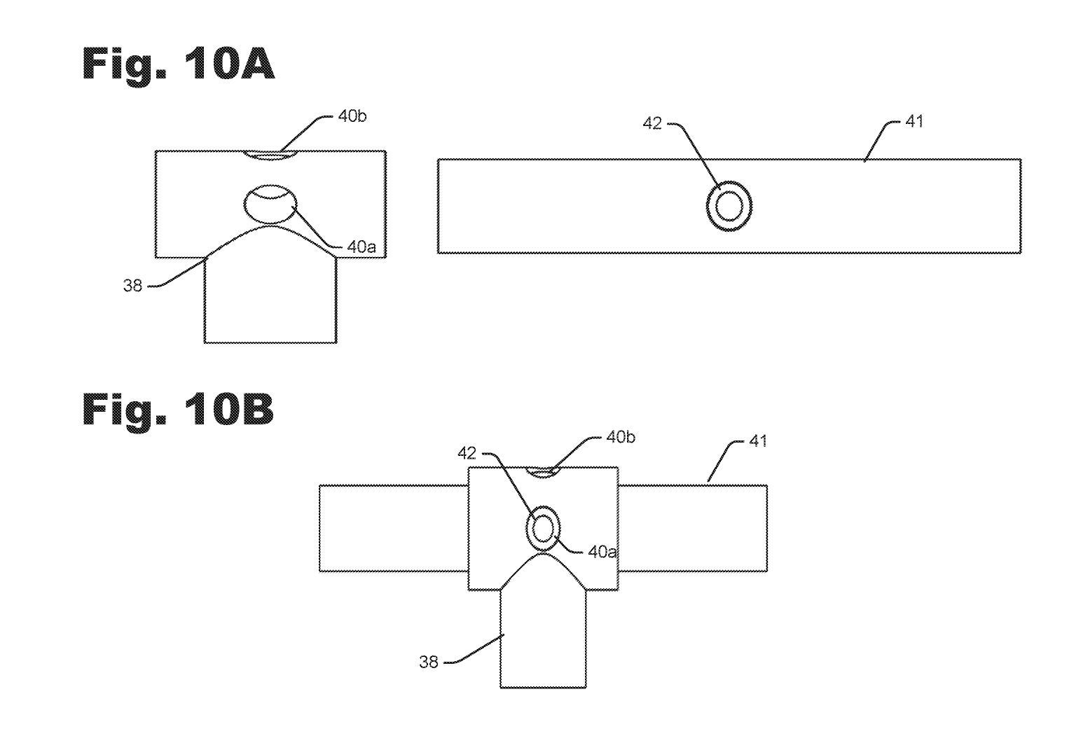

The mounting head 16 may also include a base portion 36 including a t-bar connection 38 and cross bar 41. FIGS. 10A and 10B show an example of a t-bar connection 38 of the mounting head 16 for the telescopic hand-held massager 10.

The base portion 36 may attach the elbows 18a and 18b via cross bar 41 to the t-bar 38. The t-bar 38 may be connected to the handle 12. In an example, the base portion 36 may be rotatable through the t-bar 38 to enable articulation or rotation of the elbows 18a and 18b (and hence the massager head 20, 22), e.g., in the direction of arrows 2 in FIG. 1A.

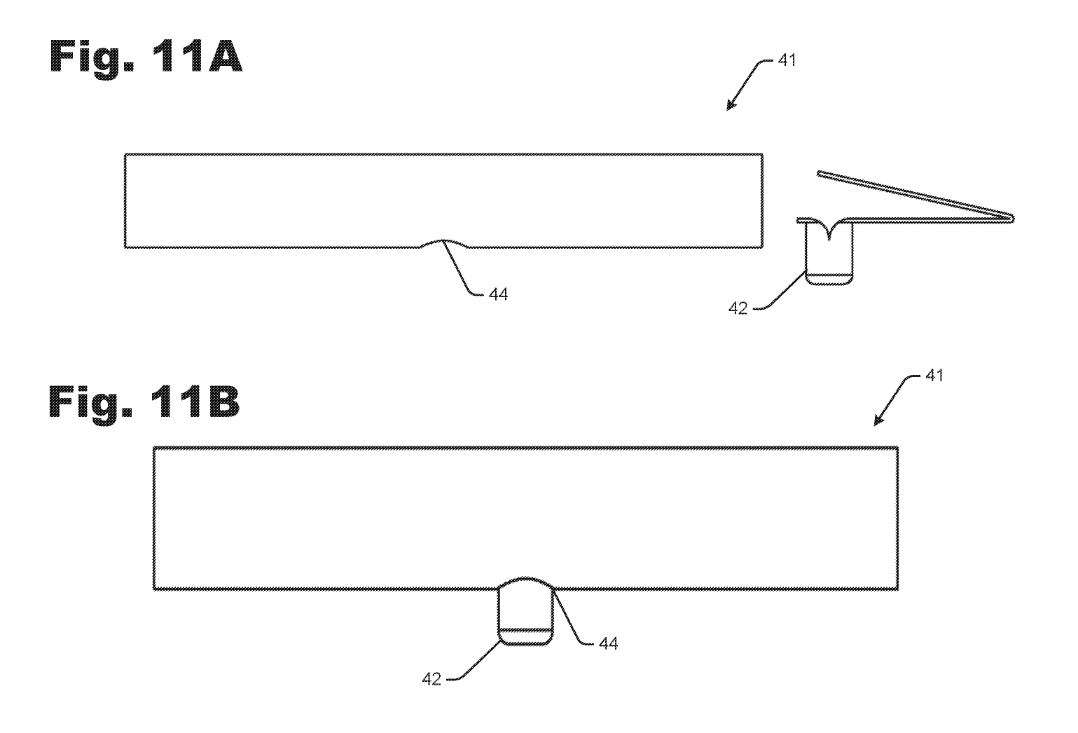

In an example, the base portion 36 may be locked, e.g., by button 42 in opening 40 of t-bar connection 38. It is noted that the t-bar connection 38 may have multiple openings 40a and 40b (or more), each providing different locking locations for various angles of head adjustment. FIGS. 11A and 11B show an example cross bar 41 for the telescopic hand-held massager 10. FIG. 11A shows the cross bar 41 with an adjustable button 44 removed from the cross bar 41. FIG. 11B shows the adjustable button 44 mounted through opening 44 in the cross bar 41.

It is noted that the examples shown and described are provided for purposes of illustration and are not intended to be limiting. Still other examples are also contemplated.

1. A telescopic hand-held massager, comprising:
an extendible and retractable handle;
a mounting head connected to the handle;
a mounting bar threaded on one end into the mounting head, wherein the mounting bar is removable from the mounting head; and
a massager head for sliding onto the mounting bar when the mounting bar is removed from the mounting head, the massager head installed in the mounting head when the mounting bar is threaded into engagement with the mounting head.

2. The telescopic hand-held massager of claim 1, wherein the massager head is interchangeable on the mounting head with at least one other massager head.

3. The telescopic hand-held massager of claim 1, wherein the mounting head is movably connected to the handle for user configuration of variable angles of operation of the massager head.

4. The telescopic hand-held massager of claim 1, wherein the mounting head is rotatable relative to the handle for user configuration of variable angles of operation of the massager head.

5. The telescopic hand-held massager of claim 1, further comprising a grip portion on the handle so that the user may readily grasp the handle.

6. The telescopic hand-held massager of claim 1, further comprising a fixed massager head.

7. The telescopic hand-held massager of claim 1, further comprising an articulating massager head.

8. The telescopic hand-held massager of claim 1, further comprising a rolling massager head.

9. The telescopic hand-held massager of claim 1, further comprising a dual roller massager head.

10. The telescopic hand-held massager of claim 1, further comprising a ball-shaped massager head.

11. The telescopic hand-held massager of claim 1, further comprising a cylindrically shaped massager head.

12. The telescopic hand-held massager of claim 1, wherein the massager head has a knobby surface.

13. The telescopic hand-held massager of claim 1, wherein the massager head has a surface with a plurality of rectangular shaped knobs.

14. The telescopic hand-held massager of claim 1, wherein the massager head has a gear-shaped side profile.

15. The telescopic hand-held massager of claim 1, wherein the mounting head has opposing elbows.

16. The telescopic hand-held massager of claim 15, wherein the mounting bar extends between the opposing elbows of the mounting head.

17. A telescopic hand-held massager, comprising:
a size-adjustable telescoping handle;
a rotatable mounting head connected to the handle;
a mounting bar in the mounting head; and
an interchangeable massager head for mounting on the mounting bar when the mounting bar is removed from the mounting head, the massager head installed in the mounting head when the mounting bar is in engagement with the mounting head.

18. The telescopic hand-held massager of claim 17, wherein the mounting head has opposing elbows and the mounting bar extends between the opposing elbows of the mounting head.

19. The telescopic hand-held massager of claim 17, wherein the mounting head is rotatable relative to the handle for user configuration of variable angles of operation of the massager head.

20. A telescopic hand-held massager, comprising:
a size-adjustable telescoping handle;
a rotatable mounting head connected to the handle, the mounting head rotating relative to the handle for user configuration of variable angles of operation;
a mounting bar in the mounting head; and
an interchangeable massager head for mounting on the mounting bar when the mounting bar is removed from the mounting head, the massager head installed in the mounting head when the mounting bar is in engagement with the mounting head.
